(19) United States
(12) Patent Application Publication
(10) Pub. No.: US 2013/0153423 A1
(43) Pub. Date: Jun. 20, 2013

(54) APPARATUS AND METHOD FOR REMOVAL OF IONS

(71) Applicants: Albert Van Der Wal, Oegstgeest (NL); Hank Robert Reinhoudt, Delft (NL); Pieter Maarten Biesheuvel, Wageningen (NL)

(72) Inventors: Albert Van Der Wal, Oegstgeest (NL); Hank Robert Reinhoudt, Delft (NL); Pieter Maarten Biesheuvel, Wageningen (NL)

(73) Assignee: VOLTEA B.V., Sassenheim (NL)

(21) Appl. No.: 13/811,622

(22) PCT Filed: Jul. 22, 2011
(86) PCT No.: PCT/NL2011/050536

§ 371 Date: Mar. 8, 2013

(30) Foreign Application Priority Data
Jul. 23, 2010 (NL) 2005135

(51) Int. Cl. C02F 1/469

(52) U.S. Cl. CPC C02F 1/4691
USPC 204/554; 204/660

(57) ABSTRACT

An apparatus and a method to remove ions from water are provided. The apparatus has at least three electrodes: at least two master electrodes, each master electrode including a current collector connected or connectable to a power supply configured to create an electrical potential difference between at least two master electrodes and at least one floating electrode located between at least two master electrodes. The apparatus is constructed to provide a potential difference between at least two master electrodes and to allow water containing ions to flow from an inlet to an outlet between at least two adjacent electrodes. The ions in the water are attracted to the master and floating electrodes by the potential difference and the at least one floating electrode has an ion barrier layer.

### FIELD

The invention relates to an apparatus to remove ions from water.

### Background

In recent years many people have become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionization, using an apparatus comprising a flow through capacitor (FTC) to remove ions from water. The FTC functions as an electrically regenerable cell for capacitive deionization. By charging one or more electrodes, ions are removed from an electrolyte and are held in an electrical double layer at the electrode. The electrode can be (partially) electrically regenerated to desorb such previously removed ions without adding chemicals. The apparatus typically comprises one or more pairs of spaced apart electrodes (a cathode and an anode) and may comprise a spacer, separating the electrodes and allowing water to flow between the electrodes.

The apparatus comprises a housing having an inlet to let water in the housing and an outlet to let water out of the housing. In the housing, the one or more pairs of electrodes (and spacers) may be stacked in a “sandwich” fashion by compressive force, normally by mechanical fastening.

### SUMMARY

Efficiency of the apparatus during purification may be relevant because it may be indicative of the amount of water that may be purified by the apparatus over a period of time. Further, efficient use of resources may be relevant for the use and/or production of the apparatus.

It is desirable, for example, to provide an improved efficiency for an apparatus to remove ions from water.

According to an embodiment, there is provided an apparatus to remove ions from water, the apparatus comprising:
a housing;
an inlet to let water into the housing;
an outlet to let water out of the housing;
at least three electrodes, comprising:
   at least two master electrodes, each master electrode comprising a current collector connected or connectable to a power supply configured to apply an electrical potential difference between at least two master electrodes; and
   at least one floating electrode located between at least two master electrodes,
the apparatus constructed to provide a potential difference between at least two master electrodes and to allow water comprising ions to flow from the inlet to the outlet between at least two adjacent electrodes,
wherein ions in the water are attracted to the master and floating electrodes by the potential difference and the at least one floating electrode comprises an ion barrier layer.

In an embodiment the ion barrier layer may be constructed and arranged to prevent anions from moving from an anode side of the floating electrode to a cathode side of the floating electrode and cations from moving from the cathode side to the anode side.

In an embodiment the floating electrode may comprise a selective charge barrier configured to prevent particular ions inside the floating electrode from leaving the floating electrode.

In an embodiment the ion barrier layer comprises a non-ion conductive layer. The non-ion conductive layer may be electrically conductive.

In an embodiment the ion barrier layer and the current collector may comprise the same material. The ion barrier layer may be within the floating electrode extending through the floating electrode parallel to the two master electrodes.

In an embodiment, a thickness of the ion barrier layer may be in a range of 5-1000 micrometers, or in a range of 10-250 micrometers. The ion barrier layer may comprise insulating material extending outwardly from an edge of the floating electrode in a longitudinal direction of the floating electrode. The insulating material may extend from the edge at least 0.5 mm or in a range of 0.5-50 mm, or in a range of 3-20 mm. The insulating material may provide one or more handling points configured to handle the electrode.

In an embodiment, at least one of the electrodes may have a substantially sheet like shape comprising a hole therein.

According to an embodiment, there is provided a method to remove ions, the method comprising:
applying an electrical potential difference between at least two master electrodes in a housing, the housing having an inlet, an outlet and at least one floating electrode located between at least two adjacent master electrodes;
allowing water to flow from the inlet to the outlet between at least two adjacent electrodes;
preventing anions from moving from an anode side of the at least one floating electrode to a cathode side of the floating electrode and cations from moving from the cathode side to the anode side; and
removing ions in the water by attracting ions to the master and floating electrodes by the potential difference.

In an embodiment the ion barrier layer may be within the floating electrode extending through the floating electrode parallel to the two master electrodes.

In an embodiment the ion barrier layer may extend outwardly from an edge of the floating electrode in a longitudinal direction of the floating electrode.

### BRIEF DESCRIPTION OF THE FIGURES

Embodiments will be described, by way of example only, with reference to the accompanying schematic drawings in which corresponding reference symbols indicate corresponding parts, and in which:

FIG. 1 shows a schematic cross-section of an electrode to remove ions;

FIG. 2 shows a schematic representation of a stack of electrodes;

FIG. 3 shows a schematic representation of an apparatus to remove ions according to an embodiment;

FIG. 4 shows a schematic representation of a master electrode with insulating material according to an embodiment;

FIG. 5 shows a schematic representation of an electrode with insulating material according to several embodiments;

FIGS. 6a and 6b show two schematic cross-sections of an edge of an electrode with insulating material according to an embodiment;

FIG. 7 shows a schematic representation of a floating electrode according to an embodiment;

FIG. 8 shows a schematic representation of a floating electrode according to an embodiment;

FIG. 9 shows a schematic representation of an apparatus to remove ions according to an embodiment;

FIG. 10 shows a schematic representation of an apparatus to remove ions according to an embodiment; and

FIGS. 11a to 11d show schematic cross-sections of an edge of an electrode with insulating material according to an embodiment.

### DETAILED DESCRIPTION

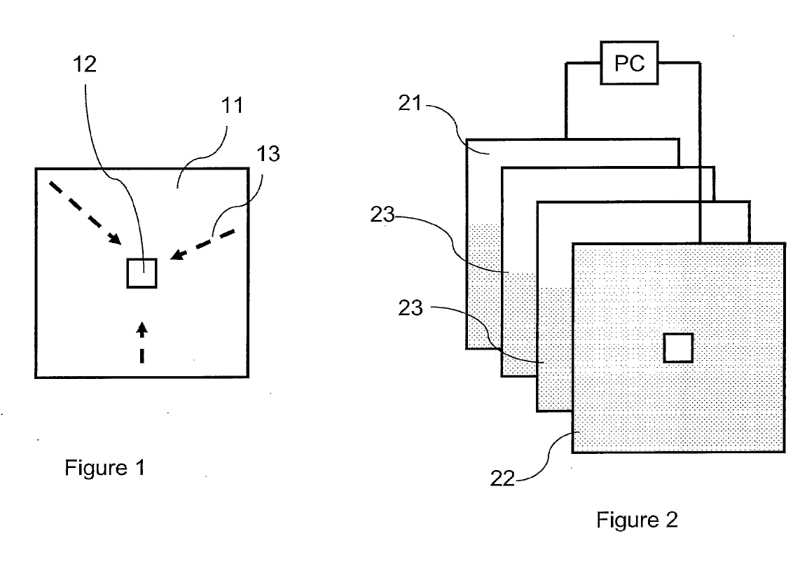

FIG. 1 shows a schematic cross section of an embodiment of an electrode, being a first master electrode or a second master electrode or a floating electrode. In this example, the electrode 11 has a sheet like shape with a rectangular form, but other shapes, such as a round shape, polygonal or a hexagonal shape are possible. The electrode may have a hole 12, which may have a rectangular shape or another shape, for example a round shape, is possible. When electrode 11 is in use, water may be flowing along the electrode from one or more outer edges towards the hole, as is indicated by the dotted arrows 13 in FIG. 1. The water may be flowing through a spacer. Typically, the outer dimensions of the electrode 11 are about 16×16 cm, 20×20 cm or 25×25 cm and the dimensions of the hole 12 are about 3×3 cm.

An advantage of a rectangular or a hexagonal shape of the electrode may be that this type of electrode may be efficiently produced with respect to the use of materials. An advantage of a round shaped electrode with a round hole in the center may be that a distance between the outer edge and the inner edge (i.e. the distance the water will flow along the electrode) is substantially constant for all flow directions.

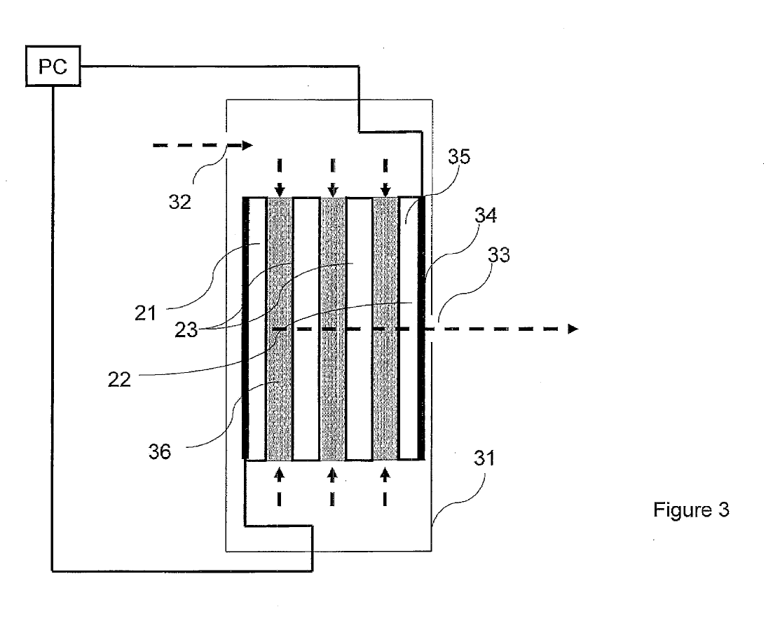

FIGS. 2 and 3 schematically show a stack of electrodes. A first master electrode 21 and a second master electrode 22 each comprise a current collector, indicated by 34 in FIG. 3, and an ion storage material, indicated by 35 in FIG. 3. The current collector may be connected to a power controller PC configured to apply an electrical potential difference between at least two master electrodes. It may be the case that the ion storage material comprises an electrically conductive layer (for example a grid) inside the ion storage material. The conductive layer may serve as the current collector and thus may be connected to the power controller PC.

The one or more electrodes in between at least two master electrodes are floating electrodes 23. A floating electrode is an electrode which is not electrically connected to the power supply PC, in contrast to a master electrode which may be electrically connected to the power supply. The number of floating electrodes is at least one.

Floating and/or master electrodes also may comprise an ion storage material. The ion storage material may store ions that have been removed from the water. The ion storage material may be a so-called high surface area material, with more than or equal to 500 m²/gr, or more than or equal to 1000 m²/gr, or more than or equal to 1500 m²/gr. The material may comprise activated carbon, carbon nanotubes, activated carbon black graphene material or carbon aerogel on both sides of the electrode which are in contact with the water or throughout the electrode.

FIG. 3 shows a schematic overview of an apparatus to remove ions according to an embodiment. The apparatus may have a housing 31 comprising an inlet 32 for water and an outlet 33 for water. During ion removal, the water will flow from the inlet 32 to the outlet 33 between pairs of adjacent electrodes. Between each pair of adjacent electrodes a spacer 36 may be provided to allow water to flow between each pair. The spacer 36 may have a shape as is depicted in FIG. 1. The main function of the spacer may be to separate two adjacent electrodes, for example by maintaining a substantially constant distance between the two electrodes. The electrodes may be clamped within the housing to provide a water leakage free apparatus.

A selective charge barrier, for example an ion exchange membrane or an ion selective membrane, may be located between a spacer and an electrode. For example, the membrane on or at a cathode may be permeable for cations, thus allowing only the transport of cations, but blocking the transport of anions. The membrane on or at an anode may be permeable for anions and block the transport of cations. The selective charge barrier may enhance the storage of ions in the ion storage material and thus improve the efficiency of the apparatus.

An electrical potential difference may be applied between the two master electrodes 21, 22, for example by applying a voltage to the first master electrode 21, i.e. the anode master electrode that is positive, with respect to a lower voltage applied to the second master electrode 22, i.e. the cathode master electrode.

Because of the applied electrical potential difference between the two master electrodes, the floating electrode may become polarized due to electron movement in the floating electrode. A polarized floating electrode may be considered as having two parts, an anode part and a cathode part. The anode part of a floating electrode is charged with a positive charge δ+ and faces the cathode master electrode or a cathode part of another floating electrode. The cathode part of a floating electrode is charged with a negative charge δ− and faces the anode master electrode or an anode part of another floating electrode.

The anions of the water flowing between a pair of adjacent electrodes are attracted to the anode master electrode or to the anode part of a floating electrode and the cations are attracted to the cathode master electrode or to the cathode part of a floating electrode. In this way the ions (both anions and cations) may be removed from the water. An element of the efficiency of the apparatus may be the number of ions removed from the water (for example from water in a spacer) to one of the electrodes per unit time per projected electrode area.

During a regeneration phase, the applied electrical potential difference between the two master electrodes may be reduced or even reversed, which subsequently may also lead to a reduced or even reversed polarity in the at least one floating electrode, causing ions stored in the electrode to disperse from the electrode into the water in between the electrodes. During the regeneration phase the water in between the electrodes may therefore have an increased ion concentration. This water is considered as waste and may be disposed.

The total potential difference between at least two master electrodes may be distributed over pairs of adjacent electrodes that are positioned between the at least two master electrodes. If the applied electrical potential difference between the master electrodes is ΔU and the number of floating electrodes is N, the electrical potential difference between each pair of adjacent electrodes may be approximately ΔU/(N+1).

The electrical potential difference between each pair of adjacent electrodes maybe rather low, for example lower than or equal to 2 volts, lower than or equal to 1.7 volts or lower than or equal to 1.5 volts. The electrical potential difference between the master electrodes may be higher, for example N+1 times higher, or in the range of 20-48 volts, or about 12 volts or 24 volts, since common power controllers and power boards provide an electrical potential difference of 12 or 24 volts.

During the removal of ions, ions may flow between two adjacent electrodes, but a high potential difference between the master electrodes may give rise to a leak current flowing between the master electrodes, between a master electrode and a non-adjacent floating electrode or between two non-adjacent floating electrodes. A high electrical potential difference between these electrodes may lead to electrolysis of water or may even cause corrosion of a master electrode or a floating electrode.

The selection of ion storage material is among others based on the ion storage capacity of the material. However, these materials tend to corrode relatively easily. For example, the ion storage material graphite may already corrode significantly at an electrical potential difference of about 2 volts. Furthermore, during the regeneration phase, the relatively high concentration of ions may further enhance the flow of leak current.

Both electrolysis and corrosion may decrease the efficiency of the apparatus. Corroded parts of the apparatus may need replacement which causes an inefficient use of resources for the apparatus. Corrosion may be avoided by using (expansive) corrosion free material.

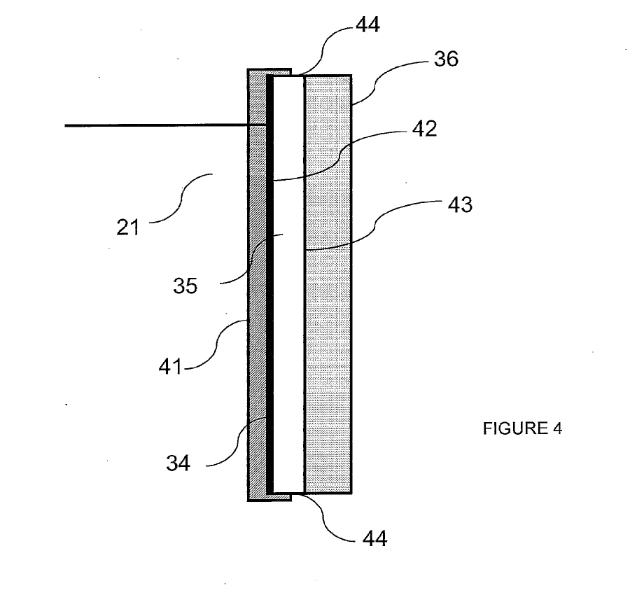

According to an embodiment, leak current may be reduced or minimized by providing a master electrode with insulating material. FIG. 4 shows as an embodiment using the first master electrode 21 from FIG. 3, but the same aspects may apply to any other master electrode. Master electrode 21 comprises a current collector 34 and an ion storage material 35. A spacer 36 is also depicted. The master electrode may comprise an insulating material 41. The electrically insulating material 41 may be placed around the current collector 34 and it may also cover a part of the ion storage material 35, as is indicated in FIG. 4. The insulating material may prevent electrical current flowing from or towards the parts that the insulating material may be covering, when in use, for example during desalination or regeneration, an electrical potential difference may be applied. This potential difference may be high, depending on the number of floating electrodes, e.g. more than 48 volts or even more than 100 volts.

The insulating material 41 may be placed on a surface 42 of the electrode that is not facing any of the other electrodes. The insulating material may also be placed on surface 44, where it may cover surface 44 completely or partly. Surface 44 is also not facing any of the other electrodes. Therefore, a surface 43 that is facing another electrode remains in contact with the water and ions may be retrieved from the water. The insulating material may reduce or minimize leak current flowing between a master electrode and a non-adjacent electrode.

The insulating material may comprise resin or any other electrically non-conductive material. An advantage of resin is that it has a high electrical resistance. Additionally or alternatively, resin may easily be applied as a liquid and it may prevent water from being in contact with the electrode. The insulating material may additionally or alternatively comprise foam rubber, which provides similar advantages as resin.

The surface 42 of the electrode 21 may be insulated by having the electrode 21 partly inside or against the housing 31. The housing may comprise the insulating material. When the insulating material is provided in the housing, only surface 44 may be covered (partly) by the insulating material. The insulating material may also be resilient in order to enable press-fitting the master electrode into a recess in the housing. Surface 42 of master electrode is then placed within the housing, such that substantially no leak current flows from or to the master electrode.

Referring to FIG. 3, it may be the case that the electrical potential difference between two non-adjacent floating electrodes may be relatively high, for example higher than 2 volts. A leak current from a floating electrode to another non-adjacent floating electrode may then also cause electrolysis or corrosion, which may lower the efficiency of the apparatus.

According to an embodiment, such leak current may be reduced, minimized or prevented by providing a thin layer of insulating material disposed on or in one of the floating electrodes, wherein the thin layer extends outwardly from an edge of the electrode in a longitudinal direction of the electrode. This longitudinal direction may be substantially parallel to a direction of the water flow along the electrode, for example through the spacer, as is indicated by arrows 13 in FIG. 1.

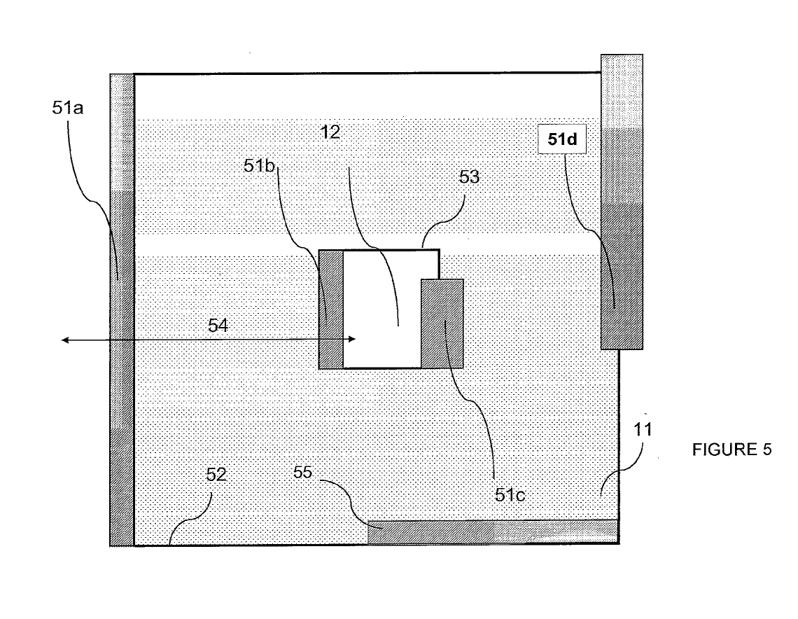

FIG. 5 depicts a schematic overview of several examples of such a thin layer. In FIG. 5 electrode 11 is an example of a floating electrode, but electrode 11 may additionally or alternatively be a master electrode. Electrode 11 comprises two edges, a first edge 52, i.e. the outer periphery of the electrode, and a second edge 53, i.e. the periphery of hole 12. Examples 51a and 51b of a thin layer of insulating material are disposed on the electrode 11 and extend outwardly from edges 52 and 53 respectively in a longitudinal direction of the electrode, which is indicated by arrow 54. The thin layer may be disposed on a part of the edge 52, 53 or along the whole edge 52, 53.

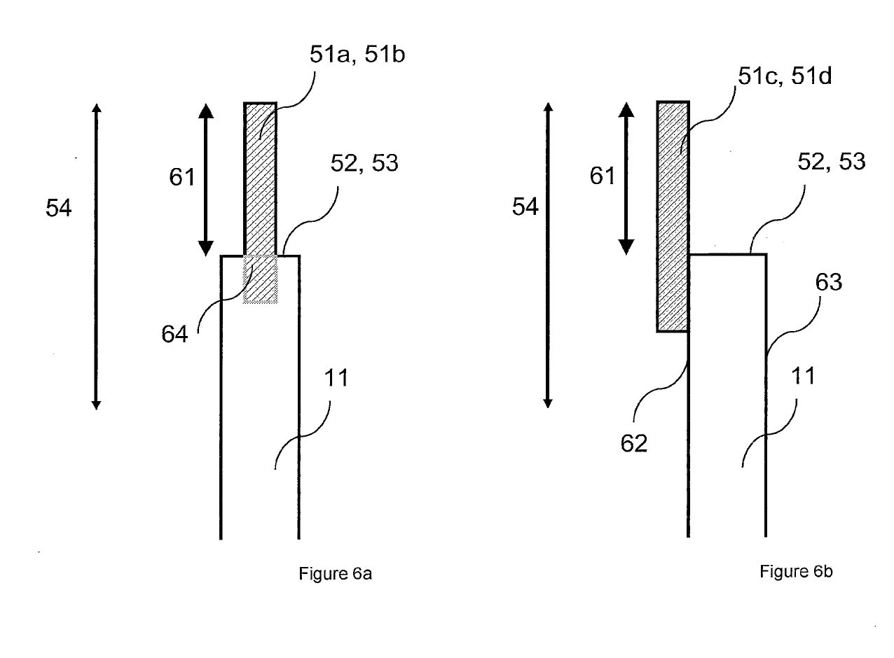

FIG. 6a depicts a schematic part of a cross section of edge 52 or 53, on which the thin layer is disposed. According to an embodiment, the thin layer of insulating material is disposed on a surface 62 of the electrode, as is indicated by examples 51c and 51d in both FIGS. 5 and 6b. Surface 62 may be facing an adjacent electrode and may be the cathode part or the anode part of a floating electrode.

Having the thin layer on surface 62 may enable the construction process to be easier and cheaper. The construction process may be further optimized when the thin layer of insulating material comprises a strip of an insulating adhesive tape, which is relatively easy to provide on the electrode 11 or on the surface 62 of the electrode 11.

The electrode 11 may be typically 0.5-1 mm thick. If the thin layer of insulating material would be thicker than these dimensions, it may influence the flow of water along the electrode, for example through the spacer. Therefore, it may be advantageous that the thickness of the thin layer is less than or equal to the thickness of the electrode, i.e. less than or equal to 1 mm or less than or equal to 0.5 mm. In a further embodiment, a second thin layer of insulating material may be provided on a second electrode surface 63, with the same characteristics as the first thin layer of insulation. The ends of both thin layers may be joined. For example, the end of a first thin layer of insulating material provided on the cathode side of a floating electrode may be joined with the end of a second thin layer of insulating material provided on the anode side of the floating electrode. This may result in better insulation and a more solid construction than when only one thin layer is disposed. This second thin layer may also comprise a strip of an isolating adhesive tape.

In an embodiment, the insulating material may be disposed partly or completely inside the electrode, for example at an edge of the electrode, as indicated by 55 in FIG. 5. This may be achieved by inserting an insulating substance into the electrode. In FIG. 6a, a part of insulating material inside the electrode is indicated by 64. This may decrease the effective area of the electrode, but may prevent leak current with minimal increase of the dimensions of the electrode.

The effect of the thin layer of insulating material according to an embodiment may be that it extends the electrical path between two non-adjacent electrodes, being master and/or floating electrodes, and thereby increases the electrical resistance between them. Higher resistance between two non-adjacent electrodes may lower the leak current between them. The thin layer of insulating material may extend from the edge 52, 53 a distance indicated by arrow 61 in FIGS. 6a and 6b. The length of an electrical path between two non-adjacent electrodes may be further increased by increasing distance 61. Therefore, distance 61 may be at least 0.5 mm or in the range of 0.5-50 mm, or in the range of 3-20 mm.

The thin layer of insulating material may be used during the production process, since the insulating material may be stronger than the ion storage material of the electrode. Since the thin layer may extend through the electrode and may even extend outwardly from the electrode, the thin layer may provide one or more handling points that may be used during the production process or during maintenance. Instead of grabbing the ion storage material, the thin layer of insulating material may be grabbed to handle the electrode. This may prevent the ion storage material from tearing, breaking or undergoing any other deformation. The insulating material may be stronger than the ion storage material, meaning it would require a larger force to tear, break or damage the insulating material than to do so with the ion storage material. The thin layer of insulating material may have features to enable a better handling of the electrode, such as one or more recesses or additional reinforcements.

A method to remove ions is also described, the method comprising a) providing a housing with an inlet and an outlet; b) providing in the housing at least three electrodes, comprising at least two master electrodes and at least one floating electrode located between at least two master electrodes; c) providing an insulating material on at least one of the two master electrodes to reduce or minimize a leak current from the master electrode to a non-adjacent electrode; d) applying an electrical potential difference between the at least two master electrodes; and e) allowing water to flow from the inlet to the outlet between two adjacent electrodes. In a further embodiment, the method further comprises b2) between steps b) and c): providing a thin layer of insulating material disposed on at least one floating electrode, the thin layer extending outwardly from an edge of the at least one floating electrode in a longitudinal direction of the at least one floating electrode.

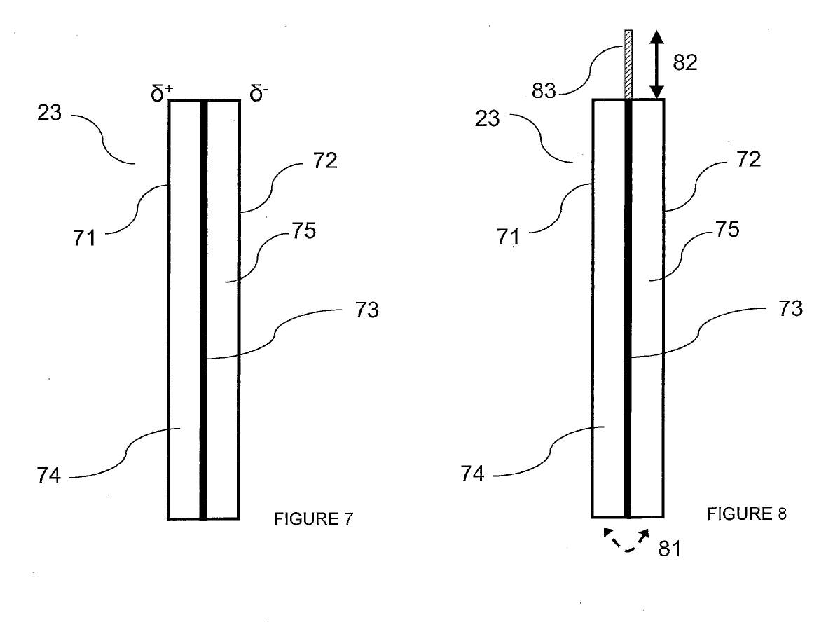

In FIG. 7 a floating electrode 23 is depicted. It is assumed that a first surface 71 is facing the cathode master electrode 22 or an adjacent cathode part of another floating electrode and that a second surface 72 is facing the anode master electrode 21 or an adjacent cathode part of another floating electrode. Floating electrode 23 may be polarized in such a way, that part 74 of the floating electrode may be considered as the anode part of the floating electrode and part 75 may be considered as the cathode part of the floating electrode.

When water is flowing along floating electrode 23, ions may be removed from the water. Anions may be stored in the ion storage material of the anode part of the floating electrode and cations may be stored in the cathode part.

According to an embodiment the floating electrode may be provided with an ion barrier layer 73. The ion barrier layer 73 separates the cations in the cathode part from the anions in the anode part and may prevent precipitation of ions at the border between the anode part and the cathode part. It would be difficult to remove these precipitates from the ion storage material, since they do not dissolve in the water. After all, the cations and anions that are stored in the ion storage material of the electrodes are commonly removed from the electrodes by an inversion of the electrical field between the master electrodes during the regeneration phase. If these precipitates are not sufficiently removed, they may lower the storage capacity of the ion storage material and therefore the efficiency of the apparatus may be decreased.

Furthermore, the ion barrier layer 73 may prevent cations from moving to the anode part and anions from moving to the cathode part, especially during the regeneration phase. Anions in the cathode side and cations in the anode part may lower the ion storage capacity of the electrode during use and thereby lower the efficiency of the apparatus.

However, for the polarization to occur in a floating electrode, it may be necessary that electrons are able to move from one side of the floating electrode (the anode part) to the other side of the floating electrode (the cathode part). Therefore, it may be advantageous that the ion barrier layer comprises a non-ion conductive layer. A non-ion conductive layer may prevent ions from passing through the layer, while permitting electrons to pass.

The ion barrier layer 73 may comprise any non-ion conductive material such as an electrically conductive polymer, graphite or titanium and may comprise the same material as a current collector. Since the floating electrode also comprises an ion storage material, both the master and floating electrodes may comprise the same materials. This would simplify the production process of the electrodes and therefore may lower the costs.

Preventing the ions from moving from one side of the floating electrode to the other side may be further optimized by having an ion barrier layer 73 that extends through the floating electrode substantially parallel to the master electrodes. It may be advantageous to divide the floating electrode in two parts by an ion barrier layer, such that both the anode part and the cathode part have substantially equal ion storage capacity. This may result in an ion barrier layer that may not be provided on a central line of the floating electrode, for example, when the storage capacity for anions per volume (cubic meter) or per weight may be different from the storage capacity for cations. A floating electrode with different anode and cathode part dimensions is referred to as an asymmetrical electrode. Other ways of dividing the floating electrode by the ion barrier layer may be applied to further optimize the ion removal.

According to an embodiment, at least one floating electrode of one of the above mentioned embodiments may be a symmetrical electrode.

According to an embodiment, the ion barrier layer may have a thickness in a range of 5-1000 micrometers, or in a range of 10-250 micrometers. The ion barrier layer may block at least 90% of the ions.

In the example above, the floating electrode may comprise only one type of ion storage material, but it is also possible to provide one type of ion storage material for the anode part and another type of ion storage material for the cathode part of the floating electrode.

FIG. 8 shows an embodiment of a floating electrode. The ion barrier layer comprises insulating material 83 extending outwardly from the floating electrode in a longitudinal direction. Because of the build-up of charge on both sides of the ion barrier layer, it may be possible that, during regeneration of the electrodes, ions stored in one side of the floating electrode may move via the water towards the other side of the floating electrode, as is indicated by arrow 81 in FIG. 8. It is possible that these ions may flow away with the water or form a precipitate in the water or in the floating electrode itself. All these effects would lower the efficiency of the apparatus.

In order to reduce or prevent this, the insulating material 83 may extend a certain length outwardly from the electrode, as is indicated by arrow 82. An optimum may be observed when the insulating material 83 extends from the edge at least 0.5 mm or in the range of 0.5-50 mm, or in the range of 3-20 mm.

The insulating material 83 may be an electrically insulating material for both electrons and ions, since a non-ion conductive material only would prevent the movement of ions, but could increase the risks of leak current.

The insulating material 83 may provide one or more handling points to handle the electrode. Instead of grabbing the ion storage material, the insulating material 83 may be grabbed to handle the electrode. The features of the thin layer of insulating material with respect to the handling of the electrode as is described above may also be applied to the ion barrier layer. In that case, the entire ion barrier layer comprising a non-ion conductive material inside the electrode and insulating material extending outwardly from the electrode, may be stronger than the ion storage material.

A method to remove ions is also described, the method comprising a) providing a housing with an inlet and an outlet; b) providing in the housing at least three electrodes, comprising at least two master electrodes and at least one floating electrode located between at least two master electrodes; c) applying an electrical potential difference between at least two master electrodes; d) allowing water to flow from the inlet to the outlet between two adjacent electrodes; and e) preventing anions from moving from an anode side of the at least one floating electrode to a cathode side of the at least one floating electrode and cations from moving from the cathode side to the anode side.

In an embodiment, an ion barrier layer may be within the floating electrode extending through the floating electrode substantially parallel to at least two master electrodes. In an embodiment, the ion barrier layer extends outwardly from an edge of the at least one floating electrode in a longitudinal direction of the at least one floating electrode.

As described above, it may be advantageous to provide an apparatus to remove ions with a stack of electrodes, wherein the two electrodes at the outermost position are connected to a power supply. These two electrodes may be referred to as master electrodes, while one or more electrodes between the two master electrodes may be referred to as a floating electrode. The electrical potential difference between the master electrodes may cause the floating electrode to polarize, causing the floating electrode to have a cathode part or cathode side and an anode part or anode side.

In an embodiment, the electrical potential difference between two adjacent electrodes, for example between an anode part of a floating electrode and a cathode part of another adjacent floating electrode or between a cathode master electrode and an anode part of an adjacent floating electrode, may be relatively low, around 1.5 volts. If such an electrical potential difference is between each pair of adjacent electrodes in FIG. 3, the electrical potential difference between the master electrodes would be around 4.5 volts, provided that the stack of electrodes may be arranged in such way that the electrical potential difference between the master electrodes may be equally divided between each pair of adjacent electrodes.

In certain applications of the apparatus to remove ions, a high water throughput may be desired. This may be achieved by increasing the number of floating electrodes between the master electrodes, for example up to and including 40 floating electrodes. The power controller would in that case supply an electrical potential difference of, for example, 60 volts or more.

There may be one or more disadvantage associated with providing such a high electrical potential difference. First, a power controller that is able to supply such a high electrical potential difference under the appropriate conditions is relatively expensive. Furthermore, a high electrical potential difference may increase the risk of leak current, flowing from an electrode to another non-adjacent electrode, thereby causing electrolysis or corrosion, as explained above. Also, a high voltage may add extra requirements to the material from which the apparatus is constructed, for example with respect to the electrical resistance of conductors and to the insulation capacity of insulators.

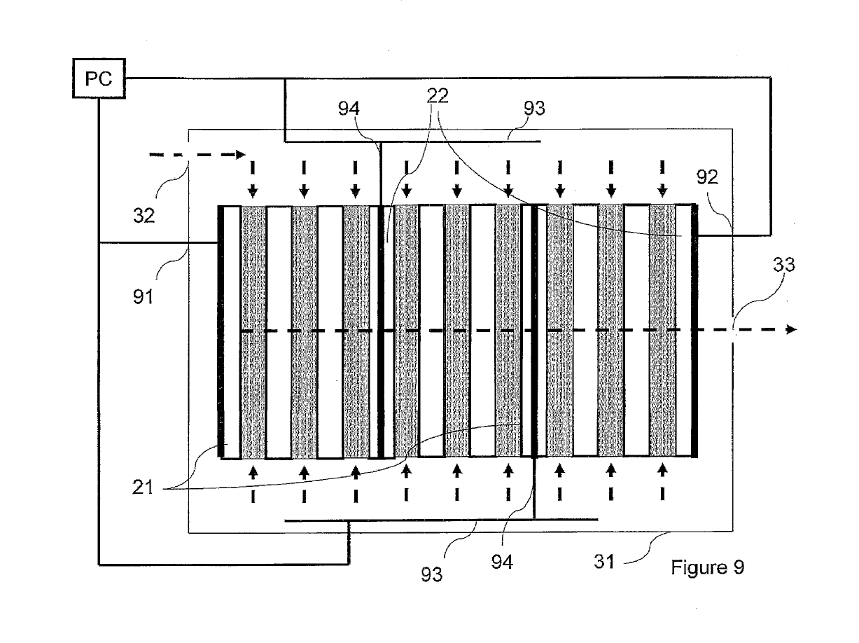

According to an embodiment, the apparatus to remove ions may comprise a stack of electrodes comprising multiple pairs of master electrodes. An example of such a stack is shown in FIG. 9. FIG. 9 shows the apparatus of FIG. 3 with an extended stack of electrodes. The stack comprises four master electrodes, which combine into three pairs of two adjacent master electrodes. The power controller may apply an electrical potential difference between the two first master electrodes 21 (the anodes) and the two second master electrodes 22 (the cathodes).

Master electrodes that are facing two other master electrodes, are part of two pairs of adjacent master electrodes, as can be seen in FIG. 9. Each pair of adjacent master electrodes comprises an anode master electrode and a cathode master electrode and form together with optional spacers and one or more floating electrodes located between the pair of master electrodes a so called cell. Some of the master electrodes are part of two cells.

A stack of electrodes comprising more than two master electrodes may also be formed by simply multiplying the stack of electrodes as is presented in FIG. 3. This would yield a construction with two separate master electrodes for each cell. Since according to an embodiment, some of the master electrodes are part of two cells, the number of master electrodes may be lower with respect to a multiplied stack of electrodes according to FIG. 3. An advantage of a lower number of master electrodes may be lower productions cost, since each master electrode not only requires a current collector and ion storage material, but also an electrical circuit connecting the master electrode to the power controller, housing material and insulation material.

Two floating electrodes are located between each pair of adjacent master electrodes in FIG. 9. However, in an embodiment, one or more than two floating electrodes may be so provided. Each of the floating electrode's may have an ion barrier layer and/or a thin layer of insulating material as described above. An advantage of a high number of floating electrodes may be lower production cost, since each floating electrode may not require a current collector and electrical circuit connecting the electrode to the power controller while at the same time offering a similar ion storage capacity as a master electrode.

Since more than one pair of master electrodes are provided, the arrangement of the stack of electrodes, i.e. the order and quantity of master electrodes and floating electrodes, may be adjusted in response to system requirements, regarding for example the water throughput or/and the maximum electrical potential difference provided by the power controller PC.

For example, a power controller that can provide 24 volts under the applicable conditions for removal of ions is common. Provided that the potential difference between two adjacent electrodes should be around 1.5 volts, a stack may be arranged comprising 16 floating electrodes between each pair of adjacent master electrodes. In this way the potential difference used in the apparatus may be 16 times higher than in a configuration where only two master electrodes would be used without floating electrodes. To get a similar removal capacity the current in the configuration with only two master electrodes would need to be 16 times higher leading to large expensive cabling and/or higher losses by the lower conductivity.

The master electrodes may have insulating material as described above. Furthermore, the master electrodes that are part of only one cell (or in other words that are facing only another electrode) may be provided inside a part of the housing, where the housing has the insulating material as described above.

The connection between the current collector of each of the master electrodes and the power controller PC may be via a hole 91, 92 through the housing 31, as indicated in FIG. 9. With respect to the construction of the apparatus, such a connection would provide a simple way of preventing contact between the water and the conductors. It may also be the case that the current collector of each of the master electrodes may be connected to the power controller via a current divider 93.

Another construction issue may concern the connection between the power controller and each of the current collectors of the master electrodes that are part of two cells. According to an embodiment a current divider 93 may be provided in the housing to connect the current collector to the power controller PC. The current divider 93 may comprise a conductive bar, which may have a circular or square cross section, and insulating material around the bar for insulating the bar from the water. This bar may extend through the housing. Since a positive voltage is to be applied to the anode master electrodes with respect to the voltage applied to the cathode master electrodes, two current dividers 93 may be provided, as is indicated in FIG. 9. To connect the above mentioned current collectors to the current divider, each current collector may have a connection wire 94 that extends outwardly from the respective master electrode in a longitudinal direction to the current divider 93.

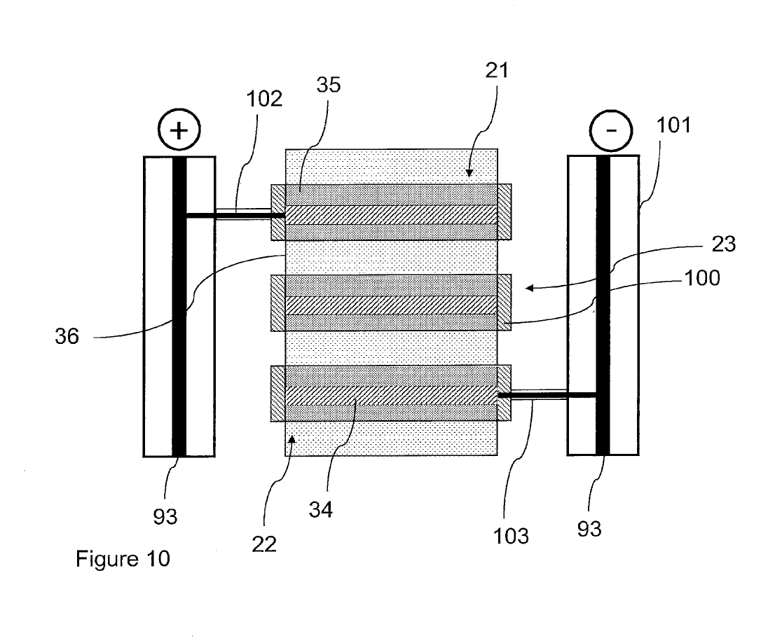

FIG. 10 shows a schematic overview of a cross section of a part of an embodiment of an apparatus to remove ions. FIG. 10 shows a part of a stack with master electrodes 21, 22, with a floating electrode 23 and several spacers 36. The stack may comprise more master electrodes and may comprise more floating electrodes, but these electrodes have not been depicted for clarity. Each electrode comprises a current collector 34 and ion storage material 35. Each electrode may have an insulating border 100. A connector 102 may be provided as a connection wire with insulating material 103 around it. The connector 102 connects the current collector 34 with the current divider 93. The connector 102 may comprise a metal rod or graphite rod or block. The current divider 93 may have an insulating material 101 to insulate the current divider from water flowing around.

A method to remove ions is described, the method comprising a) providing a housing with an inlet and an outlet; b) providing in the housing a stack of at least five electrodes comprising at least three master electrodes and at least two floating electrodes, each floating electrode located between at least two adjacent master electrodes; c) applying an electrical potential difference between each two adjacent master electrodes; and d) allowing water to flow from the inlet to the outlet between two adjacent electrodes.

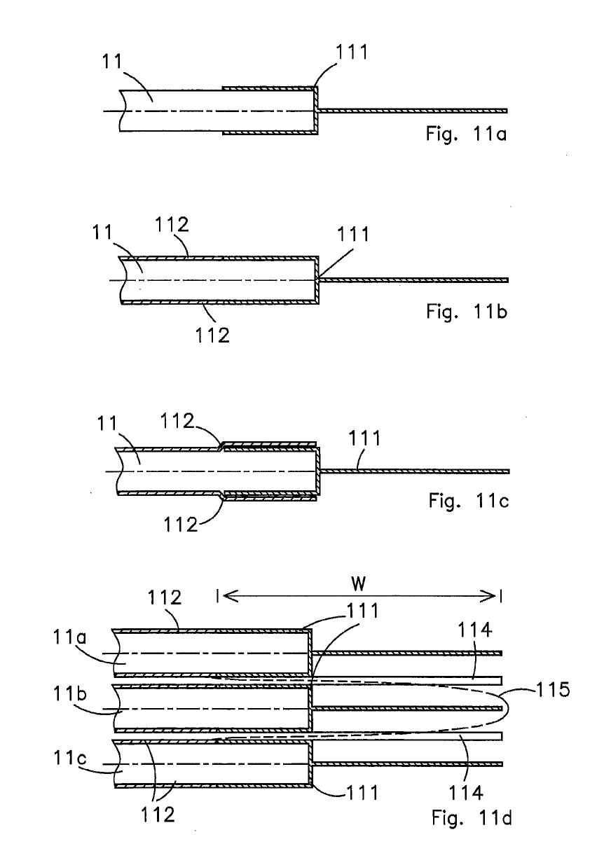

FIGS. 11a to 11d show schematic cross-sections of an edge of a floating electrode 11 having insulating material 111 according to an embodiment. In FIG. 11a the floating electrode 11 has a substantially thin layer of insulating material 111. This may be accomplished by providing a thin layer of insulating material with, for example, a thickness of less than or equal to 1000 micrometers, or in a range of 1-500 micrometers, or in a range of 5-50 micrometers. The layer may be provided with glue or may be heated or laminated on a portion of the electrode surface near the edge. For example the layer of substantially thin insulating material may be partially provided on a surface of the electrode 11, for example it may be provided 1 to 5 mm from the edge of the electrode 11 on the electrode so as to be rigidly connected to the electrode 11. The thin layer of insulating material may extend from the edge outwardly in a longitudinal direction of the electrode at least 0.5 mm or in a range of 0.5-50 mm, or in a range of 3-20 mm. The total width of the substantially thin layer of insulating material may therefore be 1 to 25 mm including the portion of the insulating material connected to the electrode and the portion extending outwardly. The substantially thin layer of insulating material may alternatively or additionally be provided only on the electrode or only extending from the edge of the electrode, however the configuration with the substantially thin layer of insulating material partly connected to the electrode and partly extending outward may be a good compromise between manufacturability and loss of electrode surface. The insulating material may be insulating for ions and for electrons.

The substantially thin layer 111 of insulating material may be provided on both sides of the floating electrode 11. The ends of both thin layers 111 may be joined. For example, the end of a first substantially thin layer of insulating material provided on the cathode side of a floating electrode may be joined with the end of a second substantially thin layer of insulating material provided on the anode side of the floating electrode. This may result in better insulation and a more solid construction than when only one substantially thin layer may be disposed. This substantially thin layer may also comprise a strip of an insulating adhesive, tape or resin or the substantially thin layer may be provided by lamination. The adhesive, tape, resin or thin layer may be insulating for ions and for electrons.

A membrane layer 112 (see FIG. 11b) may be provided on the electrode adjacent to the substantially thin layer of insulating material. The membrane may be an ion exchange membrane e.g. a membrane that may be selective for anions or cations. The membrane may have a thickness in the range of 25 to 150 microns and may be provided as a separate layer or may be coated on the electrode. It may be advantageous if the membrane layer 112 and the insulation layer 111 have a similar thickness on the electrode 11 so that the overall thickness of the electrode/membrane/electrical insulation layer may be continuous which makes stacking of the layers easier.

The membrane layer 112 may also be provided on the electrode 11 and on the substantially thin layer of insulation material (see FIG. 11c). The membrane may have a thickness in the range of 25-150 microns and may be provided as a separate layer or may be coated.

FIG. 11d shows three electrodes 11a, b, and c, each having substantially thin electrical insulation layers 111. In between the electrodes 11a, b, c, a spacer 114 may be provided to allow water to flow in between adjacent electrodes. The spacer 114 may have a thickness in the range of 50-300 microns, or in the range of 70-200 microns. This makes that the distance between two adjacent electrodes (2*membrane thickness and 1*spacer thickness) may be in the range of 100-600 microns or in the range of 120-500 microns. Between adjacent electrodes an electric potential difference in the range of 0.5-2 volts, or in the range of 0.7-1.5 volts may be applied. Because of the small distance between two adjacent electrodes this gives a sufficiently strong electric field for deionization of water flowing through the spacer 14.

There may be a path for a leakage current 115 from an electrode 11c to a non-adjacent electrode 11a. The potential difference between electrode 11a and 11c may be double the potential difference between two adjacent electrodes which may cause a chemical reaction that deteriorates the apparatus. The electrical insulation layer 111 makes the path for the leakage current 115 very long. For example if the insulating layer 111 extends 7 mm from the edge of the electrode 11 and covers 3 mm of the edge of the electrode the path for the leakage current 115 may be more than 2*(3+7)=20 mm. Compared with the distance through the neighboring electrode 11b which may be around 2 mm and may be largely determined by the 1 mm thickness of the electrode lithe path for the leakage current may be 10 times as long, thus helping to assure that most of the current may not choose for the path of the leakage current 115. It may be advantageous to have the path for the leakage current 115 at least 5 to 20 times as long as the path through the adjacent electrode. The total width W of the substantially thin layer of insulating material which may include the portion of the insulating material connected to the electrode and/or may include the portion extending outwardly from the edge may be 2-200 times, 5-50 times or 5-20 times the thickness of the electrode 11. Since the potential difference is relatively low the thickness of the insulating layer 111 may not be important but because the leakage current prefers to go around the insulating layer 111 the width W may be of importance. It may therefore be desirable to have a substantially thin layer of insulating material extending in a longitudinal direction of the electrode. The material usage may be reduced or minimized by having a substantially thin layer of insulating material while at the same time by extending it in the longitudinal direction the length of the path for the leakage current may be sufficiently long.

As depicted in FIG. 11d the electrodes 11a to 11c are floating electrodes, however the electrodes 11a and/or 11c may be replaced with a master electrode. At least one of the two master electrodes may have insulating material constructed and arranged to minimize a leak current from the master electrode to a non-adjacent electrode. The insulating material provided to the master electrode may be provided as a part of the housing. In an embodiment the electrode may have a membrane, e.g. an ion exchange membrane, and the membrane may be locally along the edges of the electrode. In an embodiment, the membrane may be insulating for ions as well. The membrane may already be insulating for electrons and further may be made insulating for ions so that it may form the insulating material. The alteration may be done for example by heating to oxidize or deteriorate the membrane or by providing a chemical compound so that by the alteration ions may not get through the membrane anymore.

The membrane may be provided on both sides of the electrode and may extend outwardly from an edge of the electrode. Extending portions may be glued together to make them more rigid. By subsequently altering the membrane that may be extending from the electrode (and optionally a portion of the membrane provided to the electrode) so that the membrane may become insulating for ions and electrodes, an extra step of providing an insulating material may be simplified by providing only a membrane and altering the membrane itself. The alteration may be done for example by heating to oxidize or deteriorate the membrane or by providing a chemical compound so that by the alteration ions may not get through the membrane anymore.

In an embodiment, two of the at least three master electrodes are partly provided inside a part of the housing. In an embodiment, each current collector of the two master electrodes may be connected to a power supply via a hole through the housing.

All of the above mentioned embodiments may be used in applications, where a high water flow may be required, i.e. ions should be removed from a water flow of at least 4 to 10 liters per minute, while the production cost of the application should be low. The above mentioned embodiments are especially suitable because of their improved efficiency. Examples of such applications are a cooling tower in a cooling system of a building, a washing machine and a coffee machine. The embodiments may also be applied at the water inlet of a house, a building, an office, a factory or groups thereof, where they may remove ions from municipal or tap water before distribution.

Embodiments may be further described by the following clauses:

1. An apparatus to remove ions from water, the apparatus comprising:
a housing;
an inlet to let water in the housing;
an outlet to let water out of the housing;
at least three electrodes in the housing, the at least three electrodes comprising:
   at least two master electrodes, each master electrode comprising a current collector connected or connectable to a power supply configured to apply an electrical potential difference between at least two master electrodes; and
   at least one floating electrode located between at least two master electrodes;
the apparatus being constructed to allow water to flow from the inlet to the outlet between two adjacent electrodes,
wherein a substantially thin layer of insulating material is provided to an edge of at least one floating electrode, the substantially thin layer extending in a longitudinal direction of the at least one floating electrode.

2. The apparatus according to clause 1, wherein a thickness of the thin layer is less than or equal to 1000 micrometers, or in a range of 0-500 micrometers, or in a range of 5-50 micrometers.

3. The apparatus according to clause 1 or clause 2, wherein the substantially thin layer comprises a strip of an adhesive insulating tape.

4. The apparatus according to any of clauses 1-3, wherein the substantially thin layer extends from the edge at least 0.5 mm or in a range of 0.5-50 mm, or in a range of 3-20 mm in the longitudinal direction of the at least one floating electrode.

5. The apparatus according to any of clauses 1-4, wherein the substantially thin layer of insulating material is at least partially fastened on a main surface of the at least one floating electrode.

6. The apparatus according to any of clauses 1-5, wherein at least one electrode has a substantially sheet like shape having a hole therein and the substantially thin layer of insulating material is provided along an edge of the hole.

7. The apparatus according to any of the preceding clauses, wherein the substantially thin layer of insulating material is provided to at least one floating electrode between additional neighboring layers.

8. The apparatus according to clause 7, wherein the additional layers comprise a spacer to allow water to flow in between adjacent electrodes.

9. The apparatus according to clause 7, wherein the additional layers comprise a membrane.

10. The apparatus according to clause 7, wherein the at least one floating electrode and the substantially thin layer of insulating material forms a plate having a substantially similar size in the longitudinal direction as the additional layers.

11. The apparatus according to clause 5, wherein the substantially thin layer of insulating material is at least partially fastened on both main surfaces of the at least one floating electrode.

12. The apparatus according to any of the preceding clauses, wherein the total width of the thin layer of insulating material in the longitudinal direction of the electrode is 2-200 times, 5-50 times or 5-20 times the thickness of the at least one floating electrode.

13. A method to remove ions, the method comprising: applying an electrical potential difference between at least two master electrodes in a housing, the housing comprising an inlet, an outlet and at least floating electrode located between at least two master electrodes, the at least one floating electrode having a thin layer of insulating material disposed to an edge of the at least one floating electrode, the thin layer extending in a longitudinal direction of the at least one floating electrode; and allowing water to flow from the inlet to the outlet between two adjacent electrodes.

14. The method according to clause 13, wherein the thin layer of insulating material is provided on two sides of the at least one floating electrode.

15. The method according to clause 13 or clause 14, wherein the thin layer of insulating material is provided by lamination.

16. An apparatus to remove ions from water, the apparatus comprising:
a housing;
an inlet to let water in the housing;
an outlet to let water out of the housing;
a stack of at least five electrodes in the housing, the at least five electrodes comprising:
   at least three master electrodes, each master electrode comprising a current collector connected to a power supply configured to apply an electrical potential difference between each two adjacent master electrodes; and
   at least two floating electrodes, each floating electrode located between two adjacent master electrodes and at least one floating electrode is constructed to attract ions from the water as a result of the electrical potential difference between the master electrodes,
the apparatus constructed to allow water to flow from the inlet to the outlet between two adjacent electrodes.

17. The apparatus according to clause 16, wherein at least two of the at least three master electrodes are partly provided against a part of the housing.

18. The apparatus according to clause 17, wherein each current collector of the at least two master electrodes is connected to the power controller via a hole through the housing.

19. The apparatus according to any of clauses 16-18, further comprising at least one connection wire arranged to respectively connect a current collector of one of the at least three master electrodes to a power supply, the connection wire extending outwardly from the one master electrode in a longitudinal direction of the one master electrode.

20. The apparatus according to clause 19, further comprising a current divider, the current divider arranged and constructed in the housing substantially parallel to the stack of at least five electrodes and configured to connect the at least one connection wire and the power supply.

21. The apparatus according to any of clauses 16-20, wherein at least one master electrode is constructed to attract ions from the water as a result of the electrical potential difference between master electrodes.

22. The apparatus according to any of clauses 16-21, wherein at least one of the floating electrodes and/or at least one of the master electrodes comprises an ion storage material to store ions from the water as a result of the electrical potential difference between master electrodes.

23. The apparatus according to clause 22, wherein the ion storage material comprises a high surface material comprising more than or equal to 500 m²/gr, more than or equal to 1000 m²/gr or more than or equal to 1500 m²/gr.

24. The apparatus according to any of clauses 16-23, wherein at least one of the floating electrodes and/or at least one of the master electrodes comprises a selective charge barrier.

25. The apparatus according to any of clauses 16-24, comprising at least two floating electrodes between two master electrodes.

26. The apparatus according to any of clauses 16-25, wherein at least one electrode has a substantially sheet like shape having a hole therein.

27. The apparatus according to any of clauses 16-26, further comprising at least one spacer arranged between two adjacent electrodes to allow water to flow in between the two adjacent electrodes.

28. A method to remove ions, the method comprising:
applying an electrical potential difference between each two adjacent master electrodes of at least three master electrodes in a housing, the housing comprising an inlet, an outlet, and at least two floating electrodes, each floating electrode located between two adjacent master electrodes;
allowing water to flow from the inlet to the outlet between two adjacent electrodes; and
removing ions in the water by attracting ions to at least one floating electrode by the electrical potential difference.

29. The method according to clause 28, further comprising removing ions in the water by attracting ions to at least one master electrode by the electrical potential difference.

30. The method according to clause 28 or clause 29, further comprising storing ions in a storage material provided to at least one floating electrode and/or to at least one master electrode.

It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Furthermore, the terms and phrases used herein are not intended to be limiting, but rather, to provide an understandable description of the invention. Elements of the above mentioned embodiments may be combined to form other embodiments.

The terms “a” or “an”, as used herein, are defined as one or more than one. The term another, as used herein, is defined as at least a second or more. The terms including and/or having, as used herein, are defined as comprising (i.e., not excluding other elements or steps). Any reference signs in the claims should not be construed as limiting the scope of the claims or the invention. The mere fact that certain measures are recited in mutually different dependent claims does not indicate that a combination of these measures cannot be used to advantage. The scope of the invention is only limited by the following claims.

1. An apparatus to remove ions from water, the apparatus comprising:
a housing;
an inlet to let water into the housing;
an outlet to let water out of the housing;
at least three electrodes in the housing, the electrodes comprising:
at least two master electrodes, each master electrode comprising a current collector connected or connectable to a power supply configured to apply an electrical potential difference between at least two master electrodes; and
at least one floating electrode located between at least two master electrodes,
the apparatus constructed to provide a potential difference between at least two master electrodes and to allow water comprising ions to flow from the inlet to the outlet between at least two adjacent electrodes,
wherein ions in the water are attracted to the master and floating electrodes by the potential difference and the at least one floating electrode comprises an ion barrier layer.

2. The apparatus according to claim 1, wherein the ion barrier layer is constructed and arranged to prevent anions from moving from an anode side of the at least one floating electrode to a cathode side of the at least one floating electrode and cations from moving from the cathode side to the anode side.

3. The apparatus according to claim 1, wherein the at least one floating electrode comprises a selective charge barrier configured to prevent particular ions inside the at least one floating electrode from leaving the at least one floating electrode.

4. The apparatus according to claim 1, wherein the ion barrier layer comprises a non-ion conductive layer.

5. The apparatus according to claim 4, wherein the non-ion conductive layer is electrically conductive.

6. The apparatus according to claim 1, wherein the ion barrier layer and the current collector comprise the same material.

7. The apparatus according to claim 1, wherein the ion barrier layer is within the at least one floating electrode, extending through the at least one floating electrode substantially parallel to at least two master electrodes.

8. The apparatus according to claim 1, wherein a thickness of the ion barrier layer is in a range of 5-1000 micrometers.

9. The apparatus according to claim 1, wherein the ion barrier layer comprises insulating material extending outwardly from an edge of the at least one floating electrode in a longitudinal direction of the at least one floating electrode.

10. The apparatus according to claim 9, wherein the insulating material extends from the edge at least 0.5 mm.

11. The apparatus according to claim 9, wherein the insulating material provides a handling point configured to handle the at least one floating electrode.

12. The apparatus according to claim 1, wherein at least one electrode has a substantially sheet like shape having a hole therein.

13. A method to remove ions, the method comprising:
applying an electrical potential difference between at least two master electrodes in a housing, the housing having an inlet, an outlet and at least one floating electrode located between at least two adjacent master electrodes;
allowing water to flow from the inlet to the outlet between at least two adjacent electrodes;
preventing anions from moving from an anode side of the at least one floating electrode to a cathode side of the at least one floating electrode and cations from moving from the cathode side to the anode side; and
removing ions in the water by attracting ions to the master and floating electrodes by the potential difference.

14. The method according to claim 13, wherein the preventing comprises using an ion barrier layer within the at least one floating electrode, extending through the at least one floating electrode substantially parallel to at least two master electrodes.

15. The method according to claim 13, wherein the preventing comprises using an ion barrier layer or an insulating material, extending outwardly from an edge of the at least one floating electrode in a longitudinal direction of the at least one floating electrode.

16. The method according to claim 15, wherein the insulating material extends from the edge at least 0.5 mm.

17. A method to remove ions, the method comprising:
applying an electrical potential difference between at least two master electrodes in a housing, the housing comprising an inlet, an outlet and at least floating electrode located between at least two master electrodes;
limiting ions from moving from an anode side of the at least floating electrode to a cathode side of the at least one floating electrode, or vice versa, by using a thin layer of insulating material disposed to an edge of the at least one floating electrode, the thin layer extending in a longitudinal direction of the at least one floating electrode; and
allowing water to flow from the inlet to the outlet between at least two adjacent electrodes.

18. The method according to claim 17, wherein the thin layer of insulating material is provided on two sides of the at least one floating electrode.

19. The method according to claim 17, wherein a thickness of the thin layer is less than or equal to 1000 micrometers.

20. The method according to claim 17, wherein the substantially thin layer extends from the edge at least 0.5 mm.
